(19) United States
(12) Patent Application Publication
(10) Pub. No.: US 2024/0001962 A1
(43) Pub. Date: Jan. 4, 2024

(54) ELECTRONIC CONTROL DEVICE

(71) Applicant: HITACHI ASTEMO, LTD., Hitachinaka-shi, Ibaraki (JP)

(72) Inventors: Yuki HORITA, Tokyo (JP); Hidehiro TOYODA, Hitachinaka-shi (JP)

(73) Assignee: HITACHI ASTEMO, LTD., Hitachinaka-shi, Ibaraki (JP)

(21) Appl. No.: 18/253,625

(22) PCT Filed: Sep. 22, 2021
(86) PCT No.: PCT/JP2021/034911

§ 371 Date: May 19, 2023

(30) Foreign Application Priority Data
Nov. 24, 2020 (JP) 2020-194767

(51) Int. Cl. B60W 60/00; B60W 30/09; B60W 30/095; B60W 40/06; B60W 40/105

(52) U.S. Cl. CPC B60W 60/0011; B60W 60/0015; B60W 30/09; B60W 30/0956; B60W 40/06; B60W 40/105; B60W 2552/35; B60W 2552/45; B60W 2554/4029; B60W 2554/4041; B60W 2555/20; B60W 2556/40

(57) ABSTRACT

An electronic control device mounted on a vehicle includes: an information acquisition unit that acquires information regarding an environmental element around the vehicle, the environmental element including at least a road surface obstacle that is passable by the vehicle on a road surface; a risk map generation unit that generates a risk map representing a degree of traveling risk of the vehicle at each position around the vehicle based on the information; and a traveling control planning unit that determines a traveling track for traveling control for the vehicle based on the risk map, in which the traveling control planning unit determines the traveling track based on the degree of traveling risk due to the road surface obstacle on the risk map through which a wheel track of the vehicle in the traveling track passes.

### TECHNICAL FIELD

The present invention relates to an electronic control device.

### BACKGROUND ART

In recent years, in order to implement comfortable and safe driving assistance and automated driving of a vehicle, a technology of detecting a falling object or the like on a road surface on which the vehicle travels and controlling a traveling track of the vehicle has been proposed. For example, PTL 1 discloses means for determining a target track for each wheel of a vehicle based on a distribution state of detected obstacles around the vehicle.

### CITATION LIST

### Patent Literature

PTL 1: WO 2018/179359 A

### SUMMARY OF INVENTION

### Technical Problem

In the invention described in PTL 1, for an obstacle that exists on a road surface around the vehicle and that the vehicle can pass over, priority is given to uniformly avoiding the obstacle as a vehicle body, and as alternative means in a case where the obstacle cannot be avoided, a target track for crossing or stepping over the obstacle is selected. However, in actual driving, it may be more natural for a vehicle to cross or step over an obstacle that the vehicle can pass over than to avoid the obstacle as a vehicle according to the degree of risk. For example, in a case where there is a small pothole at the center of a lane where the vehicle is traveling, it is natural to travel while crossing over the pothole rather than meandering to avoid the pothole as a vehicle body. Therefore, in a case of the means for uniformly handling an obstacle around the vehicle and selecting a target track as in PTL 1, it is not possible to generate a natural target track according to the degree of traveling risk of the vehicle due to the obstacle, and there is a possibility that ride comfort and safety are deteriorated.

### Solution to Problem

An electronic control device according to the present invention is an electronic control device mounted on a vehicle, the electronic control device including: an information acquisition unit that acquires information regarding an environmental element around the vehicle, the environmental element including at least a road surface obstacle that is passable by the vehicle on a road surface; a risk map generation unit that generates a risk map representing the degree of traveling risk of the vehicle at each position around the vehicle based on the information; and a traveling control planning unit that determines a traveling track for traveling control for the vehicle based on the risk map, in which the traveling control planning unit determines the traveling track based on the degree of traveling risk due to the road surface obstacle on the risk map through which a wheel track of the vehicle in the traveling track passes.

### Advantageous Effects of Invention

According to the present invention, it is possible to generate a natural target track according to the degree of traveling risk of a vehicle due to a road surface obstacle.

### BRIEF DESCRIPTION OF DRAWINGS

FIG. 1 is a functional block diagram illustrating a configuration of a vehicle system including an electronic control device according to an embodiment of the present invention.

FIG. 2 is a diagram illustrating an example of a structure of data stored in a sensor detection data group.

FIG. 3 is a diagram illustrating an example of a structure of data stored in an obstacle data group.

FIG. 4 is a diagram illustrating an example of a structure of data stored in a road surface obstacle data group.

FIG. 5 is a diagram illustrating a correlation between functions implemented by the electronic control device according to the present embodiment.

FIG. 6 is a diagram illustrating an example of a travel scene for describing an operation according to the present embodiment.

FIG. 7 is a flowchart for describing processing executed by an obstacle risk estimation unit and an obstacle risk map generation unit.

FIG. 8 is a diagram illustrating an example of an obstacle risk map generated for the travel scene of FIG. 6.

FIG. 9 is a flowchart for describing processing executed by a road surface risk estimation unit and a road surface risk map generation unit.

FIG. 10 is a diagram illustrating an example of a road surface risk map generated for the travel scene of FIG. 6.

FIG. 11 is a flowchart for describing processing executed by a traveling control planning unit.

FIG. 12 is a diagram illustrating an example of traveling track candidates.

FIG. 13 is a diagram illustrating a state in which the traveling track candidates of FIG. 12 and wheel tracks thereof are mapped on the obstacle risk map and the road surface risk map, respectively.

FIG. 14 is a diagram illustrating a state in which a traveling track candidate selected as a traveling track and a wheel track thereof are mapped to the obstacle risk map and the road surface risk map, respectively.

### DESCRIPTION OF EMBODIMENTS

Hereinafter, embodiments of the present invention will be described with reference to the drawings.

### (System Configuration)

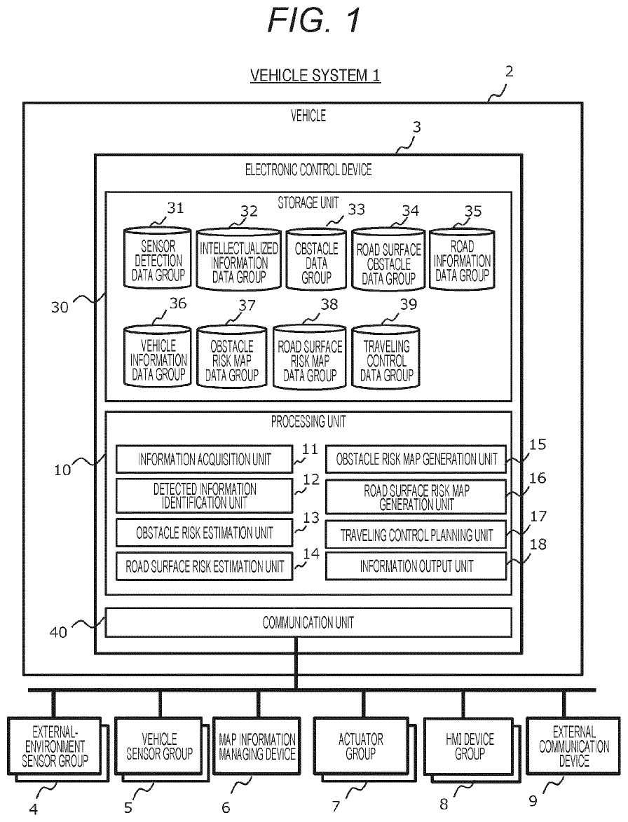

FIG. 1 is a functional block diagram illustrating a configuration of a vehicle system 1 including an electronic control device 3 according to an embodiment of the present invention. The vehicle system 1 is mounted on a vehicle 2. The vehicle system 1 recognizes a situation of an obstacle such as a traveling road or a surrounding vehicle around the vehicle 2, and then performs appropriate driving assistance and traveling control. As illustrated in FIG. 1, the vehicle system 1 includes the electronic control device 3, an external-environment sensor group 4, a vehicle sensor group 5, a map information managing device 6, an actuator group 7, an HMI device group 8, and an external communication device 9. The electronic control device 3, the external-environment sensor group 4, the vehicle sensor group 5, the map information managing device 6, the actuator group 7, the HMI device group 8, and the external communication device 9 are connected to each other by an in-vehicle network N. Hereinafter, the vehicle 2 may be referred to as an “own vehicle” 2 in order to be distinguished from other vehicles.

The electronic control device 3 is an electronic control unit (ECU) that executes arithmetic processing for performing driving assistance and traveling control for the vehicle 2. The electronic control device 3 generates traveling control information for driving assistance or automated driving of the vehicle 2 based on various types of input information provided from the external-environment sensor group 4, the vehicle sensor group 5, the map information managing device 6, the external communication device 9, and the like, and outputs the traveling control information to the actuator group 7, the HMI device group 8, and the like. The electronic control device 3 includes a processing unit 10, a storage unit 30, and a communication unit 40.

The processing unit 10 includes, for example, a central processing unit (CPU). However, the processing unit 10 may include, in addition to the CPU, a graphics processing unit (GPU), a field-programmable gate array (FPGA), an application specific integrated circuit (ASIC), or the like, or may be implemented by any one of them.

The processing unit 10 includes, as functions thereof, an information acquisition unit 11, a detected information identification unit 12, an obstacle risk estimation unit 13, a road surface risk estimation unit 14, an obstacle risk map generation unit 15, a road surface risk map generation unit 16, a traveling control planning unit 17, and an information output unit 18. The processing unit 10 implements these functions by executing a predetermined operation program stored in the storage unit 30.

The information acquisition unit 11 acquires various types of information from other devices connected to the electronic control device 3 via the in-vehicle network N, and stores the information in the storage unit 30. For example, detected information regarding an environmental element around the vehicle 2 detected by the external-environment sensor group 4 is acquired and stored in the storage unit 30 as sensor detection data group 31. The environmental element for which the information acquisition unit 11 acquires the detected information from the external-environment sensor group 4 is various objects and road surface conditions around the vehicle 2 that affect traveling of the vehicle 2, and includes an object that the vehicle 2 can pass over on a road surface (hereinafter, referred to as “road surface obstacle”), an object that the vehicle 2 cannot pass over (hereinafter, referred to as “obstacle”), and the like.

In addition to the sensor detection data group 31, the information acquisition unit 11 acquires information related to a movement, a state, and the like of the vehicle 2 detected by the vehicle sensor group 5 and the like, and stores, in the storage unit 30, the information as a vehicle information data group 36. In addition, the information acquisition unit 11 acquires information related to a traveling road of the vehicle 2 from the map information managing device 6, and stores, in the storage unit the information as a road information data group 35. Furthermore, information regarding traveling environment information that has been intellectualized in a center outside the vehicle or the like is acquired via the external communication device 9, and is stored in the storage unit 30 as an intellectualized information data group 32.

The detected information identification unit 12 specifies a characteristic of each environmental element in the traveling environment around the vehicle 2, for example, the type, movement, or size of the object, the road surface condition, or the like, based on the information such as the sensor detection data group 31 and the intellectualized information data group 32 acquired by the information acquisition unit 11 and stored in the storage unit 30. Based on the characteristic of each environmental element specified in this way, it is determined whether the environmental element indicated by each piece of information should be handled as an obstacle or a road surface obstacle in the subsequent processing. Based on the determination result, the detected information identification unit 12 classifies the information included in the sensor detection data group 31 and the intellectualized information data group 32 into obstacle information regarding an obstacle or road surface obstacle information regarding a road surface obstacle. Then, the obstacle information is stored as an obstacle data group 33, and the road surface obstacle information is stored as a road surface obstacle data group 34 in the storage unit 30.

The obstacle risk estimation unit 13 estimates an obstacle risk indicating the degree of influence of the obstacle around the vehicle 2 on traveling of the vehicle 2 with respect to the environmental element determined by the detected information identification unit 12 to be handled as the obstacle based on the information indicating the characteristic (position information, speed information, and the like) and a context of the traveling environment. Here, a region where there is a risk of collision between the obstacle and the vehicle 2 and the degree thereof are estimated as the obstacle risk.

The road surface risk estimation unit 14 estimates a road surface risk indicating the degree of influence of the road surface obstacle around the vehicle 2 on traveling of the vehicle 2 with respect to the environmental element determined by the detected information identification unit 12 to be handled as the road surface obstacle based on the information indicating the characteristic (position information, speed information, and the like) and a context of the traveling environment. Here, the degree of “undesirability” of stepping over the road surface obstacle by the wheel of the vehicle 2 and the region are estimated as the road surface risk. The undesirability here is evaluated by a method to be described below based on a bad influence on the ride comfort and safety of the vehicle 2, the surrounding traveling environment, and the like.

The obstacle risk map generation unit 15 generates an obstacle risk map in which the region of the obstacle risk estimated by the obstacle risk estimation unit 13 and the degree thereof are reflected on a two-dimensional map for the environmental element determined to be handled as an obstacle by the detected information identification unit 12. Information of the obstacle risk map generated by the obstacle risk map generation unit 15 is stored in the storage unit 30 as an obstacle risk map data group 37.

The road surface risk map generation unit 16 generates a road surface risk map in which the region of the road surface risk estimated by the road surface risk estimation unit 14 and the degree thereof are reflected on a two-dimensional map for the environmental element determined to be handled as a road surface obstacle by the detected information identification unit 12. Information of the road surface risk map generated by the road surface risk map generation unit 16 is stored in the storage unit as a road surface risk map data group 38.

In the electronic control device 3, the obstacle risk map generation unit 15 and the road surface risk map generation unit 16 described above can generate a risk map representing the degree of traveling risk of the vehicle 2 at each position around the vehicle 2.

The traveling control planning unit 17 plans a track on which the vehicle 2 should travel based on the obstacle risk map generated by the obstacle risk map generation unit 15 and the road surface risk map generated by the road surface risk map generation unit 16, and determines the track as a traveling track for traveling control for the vehicle 2. Then, a control command value to be output to the actuator group 7 for following the determined traveling track is determined, and traveling control information based on the determined control command value is generated. The traveling control information generated by the traveling control planning unit 17 is stored in the storage unit 30 as a traveling control data group 39.

The information output unit 18 outputs various type of information to another device connected to the electronic control device 3 via the in-vehicle network N. For example, the electronic control device 3 outputs the traveling control information including the control command value determined by the traveling control planning unit 17 to the actuator group 7 to perform traveling control for the vehicle 2. In addition, for example, the electronic control device 3 outputs, to the HMI device group 8, the information such as the obstacle risk map generated by the obstacle risk map generation unit 15, the road surface risk map generated by the road surface risk map generation unit 16, the traveling track of the vehicle 2 planned when the traveling control planning unit 17 generates the traveling control information, and presents to an occupant how the vehicle system 1 interprets the traveling environment around the vehicle 2 under automatic control and how the vehicle system 1 plans traveling.

The storage unit 30 includes, for example, a storage device such as a hard disk drive (HDD), a flash memory, or a read only memory (ROM), and a memory such as a random access memory (RAM). The storage unit 30 stores a program to be processed by the processing unit 10, a data group necessary for the processing, and the like. In addition, as a main storage when the processing unit 10 executes the program, the storage unit 30 is also used for temporarily storing data necessary for operation of the program. In the present embodiment, as information for implementing the functions of the electronic control device 3, the sensor detection data group 31, the intellectualized information data group 32, the obstacle data group 33, the road surface obstacle data group 34, the road information data group 35, the vehicle information data group 36, the obstacle risk map data group 37, the road surface risk map data group 38, the traveling control data group 39, and the like are stored in the storage unit 30.

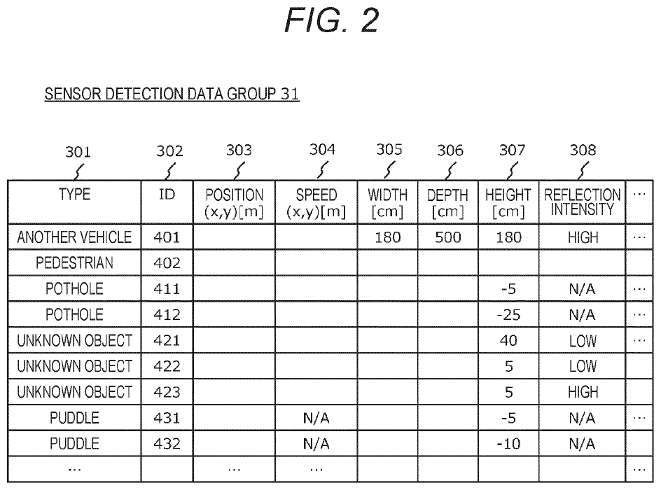

The sensor detection data group 31 is a set of data regarding the detected information from the external-environment sensor group 4. The detected information is, for example, information regarding environmental elements such as objects and road surface conditions around the vehicle 2 specified by the external-environment sensor group 4 based on the sensing information, and includes the obstacle information regarding an obstacle and the road surface obstacle information regarding a road surface obstacle as described above. A data expression example of the sensor detection data group 31 will be described below with reference to FIG. 2. The sensor detection data group 31 is acquired from the external-environment sensor group 4 by the information acquisition unit 11 and stored in the storage unit 30.

The intellectualized information data group 32 is a set of data regarding intellectualized information acquired from a center server or the like installed outside the vehicle 2 via the external communication device 9. The intellectualized information includes, for example, information such as positions of semi-static objects (construction regions and the like) and road surface conditions (potholes, bumps, and the like) existing on a road, the information being generated by collecting and analyzing detected information of a plurality of vehicles 2. Similarly to the sensor detection data group 31, the intellectualized information data group 32 includes the obstacle information regarding an obstacle and the road surface obstacle information regarding a road surface obstacle. Furthermore, the intellectualized information data group 32 has, for example, a data format similar to that of the sensor detection data group 31, and can be handled in the processing unit 10 similarly to the sensor detection data group 31. The intellectualized information data group 32 is acquired from the external communication device 9 by the information acquisition unit 11 and stored in the storage unit 30.

The obstacle data group 33 is a set of data regarding information of an environmental element determined to be handled as an obstacle by the detected information identification unit 12 among pieces of information of the sensor detection data group 31 and the intellectualized information data group 32. Meanwhile, the road surface obstacle data group 34 is a set of data regarding information of an environmental element determined to be handled as a road surface obstacle by the detected information identification unit 12 among pieces of information of the sensor detection data group 31 and the intellectualized information data group 32. Here, as described above, in the present specification, among environmental elements existing around the vehicle 2, an environmental element that the vehicle 2 cannot pass over without crossing is defined as an “obstacle”, and an environmental element that the vehicle 2 can pass over by crossing is defined as a “road surface obstacle”. Here, “crossing” means that an environmental element existing on the road surface is passed under the vehicle body of the vehicle 2 while the vehicle 2 is traveling, so that the vehicle 2 passes over the environmental element. That is, it is not always necessary for the wheel of the vehicle 2 to step over the environmental element, and the environmental element may be passed under the vehicle body between the wheels.

The road information data group 35 is a set of data regarding a traveling road around the vehicle 2 acquired from the map information managing device 6 or the like. The data regarding the traveling road includes, for example, information regarding a road on which the vehicle 2 is traveling and a shape or an attribute (a traveling direction, a speed limit, a traveling regulation, or the like) of a lane of the road. The road information data group is acquired from the map information managing device 6 by the information acquisition unit 11 and stored in the storage unit 30. In the present specification, the above-described intellectualized information data group 32 is targeted at semi-static information that may change over time, whereas the road information data group 35 is mainly targeted at static information that does not change unless a road construction work or the like is done.

The vehicle information data group 36 is a set of data regarding the movement, the state, and the like of the vehicle 2. The vehicle information data group 36 includes, as vehicle information detected by the vehicle sensor group 5 and the like and acquired by the information acquisition unit 11, for example, information such as a position, a traveling speed, a steering angle, an accelerator operation amount, a brake operation amount, a traveling route, and the like of the vehicle 2.

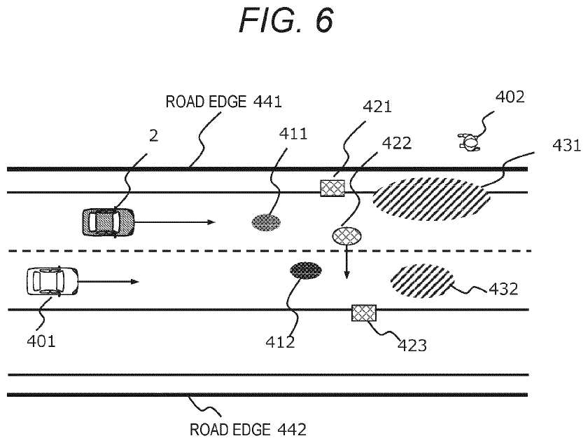

The obstacle risk map data group 37 is a set of data representing the obstacle risk map generated by the obstacle risk map generation unit 15. The obstacle risk map is a map representing a place where there is a risk of collision of the vehicle body of the vehicle 2 with an obstacle around the vehicle 2 and the degree of risk. That is, the obstacle risk map is a map representing the degree of traveling risk related to the vehicle body of the vehicle 2 at each position around the vehicle 2. The obstacle risk map is expressed by a grid-like map, for example, as illustrated in FIG. 6 to be described below.

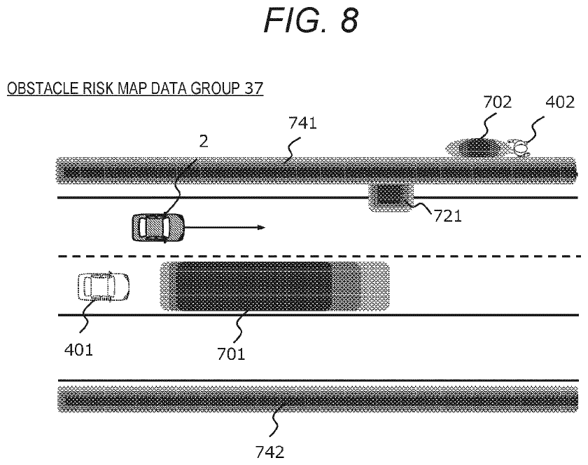

The road surface risk map data group 38 is a set of data representing the road surface risk map generated by the road surface risk map generation unit 16. The road surface risk map is a map representing “undesirability” in a case where the wheel of the vehicle 2 steps over a road surface obstacle around the vehicle 2, that is, the degree of influence on traveling of the vehicle 2 and an occurrence region thereof. In other words, the road surface risk map is a map representing the degree of traveling risk related to the wheel of the vehicle 2 at each position around the vehicle 2. The road surface risk map is expressed by, for example, a grid-like map similar to the obstacle risk map data group 37 as illustrated in FIG. 8 to be described below.

The traveling control data group 39 is a set of data regarding plan information for controlling traveling of the vehicle 2, generated by the traveling control planning unit 17. For example, the traveling control data group 39 includes the traveling track of the vehicle 2 planned by the traveling control planning unit 17, the control command value output to the actuator group 7, and the like.

The communication unit 40 has a function for communication with other devices connected via the in-vehicle network N. The communication function of the communication unit 40 is used when the information acquisition unit 11 acquires various information from other devices via the in-vehicle network N or when the information output unit 18 outputs various information to other devices via the in-vehicle network N. The communication unit 40 includes, for example, a network card or the like conforming to a communication standard such as IEEE 802.3 or a controller area network (CAN). The communication unit 40 transmits and receives data to and from the electronic control device 3 and other devices in the vehicle system 1 based on various protocols.

Note that, in the present embodiment, the communication unit 40 and the processing unit 10 are described separately, but a part of the processing performed by the communication unit 40 may be performed by the processing unit 10. For example, hardware devices for the communication processing are located in the communication unit 40, and other device driver groups, communication protocol processing, and the like are located in the processing unit 10.

The external-environment sensor group 4 is an assembly of devices that detect the state around the vehicle 2. The external-environment sensor group 4 corresponds to, for example, various sensors such as a camera device, a millimeter wave radar, LiDAR, and sonar. The external-environment sensor group 4 detects environmental elements such as objects or road surface conditions in a predetermined range from the vehicle 2, and outputs information regarding these detection results to the electronic control device 3 via the in-vehicle network N. The “object” is, for example, another vehicle that is a vehicle other than the vehicle 2, a pedestrian, a falling object on a road, a road edge, or the like. The “road surface condition” relates to the condition of the road surface, and is, for example, a depression (pothole) on the road surface, a bump, a rut, a puddle, a pavement state, a frozen state, or the like. The external-environment sensor group 4 can detect these objects or road surface conditions around the vehicle 2 as environmental elements that affect traveling of the vehicle 2.

The vehicle sensor group 5 is an assembly of devices that detect various states of the vehicle 2. Each vehicle sensor detects, for example, position information, a traveling speed, a steering angle, an accelerator operation amount, a brake operation amount, and the like of the vehicle 2, and outputs the detected information to the electronic control device 3 via the in-vehicle network N.

The map information managing device 6 is a device that manages and provides digital map information around the vehicle 2. The map information managing device 6 includes, for example, a navigation device or the like. The map information managing device 60 includes, for example, digital road map data of a predetermined region including the surroundings of the vehicle 2, and is configured to specify the current position of the vehicle 2 on the map, that is, a road or lane on which the vehicle 2 is traveling, based on the position information of the vehicle 2 output from the vehicle sensor group 5 and the like. In addition, the specified current position of the vehicle 2 and map data around the vehicle 2 are output to the electronic control device 3 via the in-vehicle network N.

The actuator group 7 is a device group that controls a control element such as steering, a brake, and an accelerator that determine the movement of the vehicle. The actuator group 7 controls the movement of the vehicle based on information regarding operation of a steering wheel, a brake pedal, an accelerator pedal, and the like by a driver and the control information output from the electronic control device 3.

The HMI device group 8 is a device group for inputting information to the vehicle system 1 by the driver or occupant and notifying the driver or occupant of information by the vehicle system 1. The HMI device group 8 includes a display, a speaker, a vibrator, a switch, and the like.

The external communication device 9 is a communication module that performs wireless communication with the outside of the vehicle system 1. The external communication device 9 is configured to be able to communicate with, for example, a center system (not described) that provides and distributes services to the vehicle system 1 and the Internet.

### (Sensor Detection Data Group 31)

FIG. 2 is a diagram illustrating an example of a structure of some data stored in the sensor detection data group 31. The sensor detection data group 31 includes information such as a type 301, an ID 302, a position 303, a speed 304, a width 305, a depth 306, a height 307, and a reflection intensity 308 for each detected information acquired for each environmental element by the external-environment sensor group 4.

The type 301 is information regarding the type of each environmental element identified by the external-environment sensor group 4. Examples thereof include another vehicle, a two-wheeled vehicle, a pedestrian, a road edge, a falling object, a pothole, a bump, a rut, a puddle, and black ice. In a case where the external-environment sensor group 4 cannot identify the type, the type is expressed as an unknown object.

The ID 302 is information regarding an identifier of each environmental element.

The position 303 is information regarding the relative position of each environmental element with respect to the vehicle 2. Normally, an object or road surface condition detected as an environmental element around the vehicle 2 by the external-environment sensor group 4 has a width or a depth (length), and thus the relative position expressed here is a position of a reference point of the environmental element. For example, a center point of a shape (a rectangle, a circle, or the like) representing the environmental element corresponds to the reference point.

The speed 304 represents information regarding a speed vector for the vehicle 2 in a case where each environmental element is a moving object.

The width 305, the depth 306, and the height 307 are information regarding the shape of each environmental element. The width 305 represents a length in a direction perpendicular to the traveling direction of the vehicle 2, the depth 306 represents a length in the traveling direction of the vehicle 2, and a height 307 represents the size of a step with respect to the road surface. The height 307 has a negative value in a case of an environmental element recessed from the road surface like a pothole. Although the item is assumed to be represented by a rectangle or a circle, the item may be represented by a polygon of a point sequence.

In a case where the reflection intensity 308 is detected using a sensor of a type that performs detection using a reflection wave of an irradiated electromagnetic wave (such as a millimeter wave radar or a LiDAR) among various sensors included in the external-environment sensor group 4, information regarding the intensity of the reflection wave is stored.

In the sensor detection data group 31 of FIG. 2, pieces of information of Reference Signs 301 to 308 described above are set for each piece of detected information. As a result, the characteristic of each environmental element identified by the external-environment sensor group 4 can be expressed in the detected information set for each environmental element.

### (Obstacle Data Group 33)

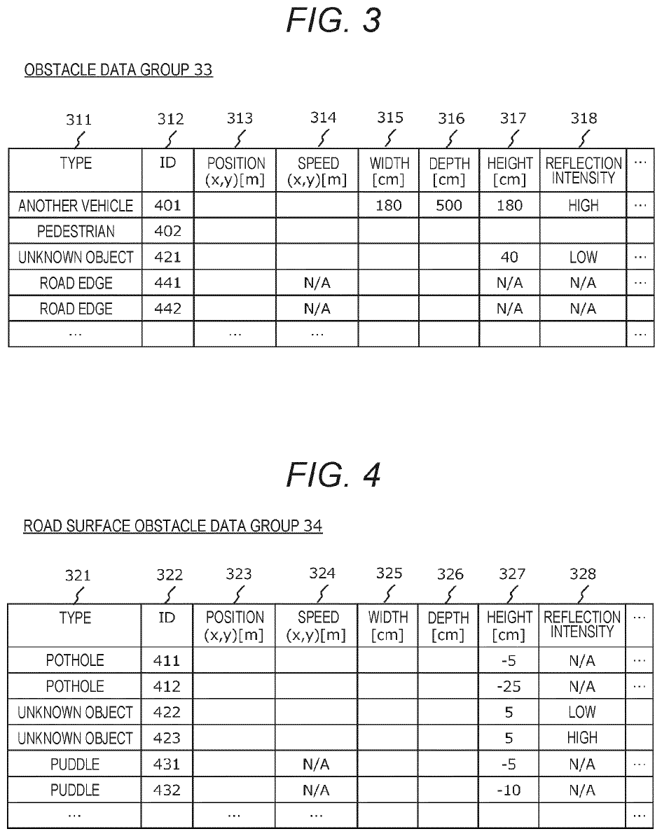

FIG. 3 is a diagram illustrating an example of a structure of some data stored in the obstacle data group 33. The obstacle data group 33 includes a type 311, an ID 312, a position 313, a speed 314, a width 315, a depth 316, a height 317, a reflection intensity 318, and the like. These pieces of information respectively correspond to the pieces of information of the type 301, the ID 302, the position 303, the speed 304, the width 305, the depth 306, the height 307, and the reflection intensity 308 included in the sensor detection data group 31 of FIG. 2.

In the example of FIG. 3, among the pieces of detected information included in the sensor detection data group 31 illustrated in FIG. 2, detected information of each environmental element determined by the detected information identification unit 12 to be handled as an obstacle is set as the obstacle data group 33. Specifically, in FIG. 2, for an environmental element of which the value of the type 301 is “another vehicle” and the value of the ID 302 is “401” (hereinafter, referred to as “another vehicle 401”), an environmental element of which the value of the type 301 is “pedestrian” and the value of the ID 302 is “402” (hereinafter, referred to as “pedestrian 402”), an environmental element of which the value of the type 301 is “unknown object” and the value of the ID 302 is “421” (hereinafter, referred to as “unknown object 421”), and environmental elements of which the values of the type 301 are “road edge” and the values of the ID 302 are “441” and “442” (hereinafter, referred to as “road edge 441” and “road edge 442”), the detected information thereof is stored in the obstacle data group 33 of FIG. 3.

### (Road Surface Obstacle Data Group 34)

FIG. 4 is a diagram illustrating an example of a structure of some data stored in the road surface obstacle data group 34. The road surface obstacle data group 34 includes a type 321, an ID 322, a position 323, a speed 324, a width 325, a depth 326, a height 327, a reflection intensity 328, and the like. These pieces of information respectively correspond to the pieces of information of the type 301, the ID 302, the position 303, the speed 304, the width 305, the depth 306, the height 307, and the reflection intensity 308 included in the sensor detection data group 31 of FIG. 2.

In the example of FIG. 4, among the pieces of detected information included in the sensor detection data group 31 illustrated in FIG. 2, detected information of each environmental element determined by the detected information identification unit 12 to be handled as a road surface obstacle is set as the road surface obstacle data group 34. Specifically, in FIG. 2, for environmental elements of which the values of the type 301 are “pothole” and the values of the ID 302 are “411” and “412” (hereinafter, referred to as “pothole 411” and “pothole 412”), environmental elements of which the values of the type 301 are “unknown object” and the values of the ID 302 are “422” and “423” (hereinafter, referred to as “unknown object 422” and “unknown object 423”), and environmental elements of which the values of the type 301 are “puddle” and the values of the ID 302 are “431” and “432” (hereinafter, referred to as “puddle 431” and “puddle 432”), the detected information thereof is stored in the road surface obstacle data group 34 of FIG. 4.

### (System Operation)

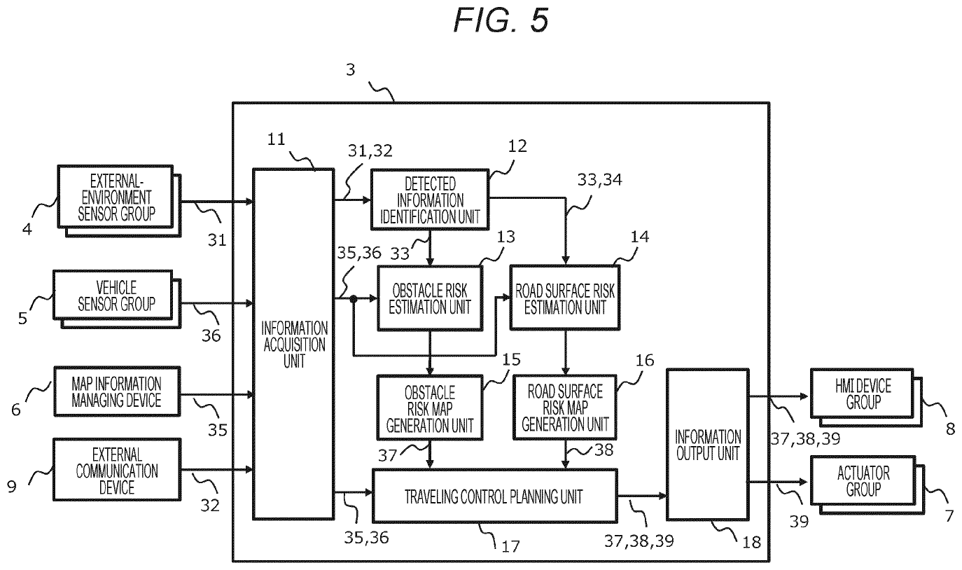

The operation of the vehicle system 1 will be described with reference to FIGS. 5 to 14. The electronic control device 3 determines and maps a traveling risk of the vehicle 2 with respect to an obstacle and road surface obstacle around the vehicle 2 based on the information acquired from the external-environment sensor group 4, the external communication device 9, and the like, and generates and outputs the traveling control information of the vehicle 2. The actuator group 7 controls the actuators of the vehicle 2 according to the cruise control information output from the electronic control device 3, thereby implementing cruise control for the vehicle 2. In addition, the electronic control device 3 generates HMI information as information to be notified to the driver or occupant and outputs the HMI information to the HMI device group 8 in traveling control for the vehicle 2. As a result, it is possible to cause the driver to recognize a risk in traveling to urge safe driving and to present the state of the vehicle system 1 during automated traveling to the driver or occupant.

FIG. 5 is a diagram illustrating a correlation between functions implemented by the electronic control device 3 according to the present embodiment. For example, as illustrated in FIG. 5, the electronic control device 3 is configured to sequentially execute processings of the information acquisition unit 11, the detected information identification unit 12, the obstacle risk estimation unit 13, the road surface risk estimation unit 14, the obstacle risk map generation unit 15, the road surface risk map generation unit 16, the traveling control planning unit 17, and the information output unit 18 in FIG. 1. The series of processing is periodically executed, for example, every 100 ms.

The information acquisition unit 11 acquires necessary information from other devices via the in-vehicle network N and stores the acquired information in the storage unit 30. Specifically, the sensor detection data group 31 is acquired from the external-environment sensor group 4, the vehicle information data group 36 is acquired from the vehicle sensor group 5, the road information data group 35 is acquired from the map information managing device 6, and the intellectualized information data group 32 is acquired from the external communication device 9, and these acquired data groups are stored in the storage unit 30 and delivered to a processing unit in the subsequent stage.

The detected information identification unit 12 identifies an environmental element such as an object or road surface condition in the traveling environment around the vehicle 2, based on the sensor detection data group 31 and the intellectualized information data group 32 acquired from the information acquisition unit 11. After determining whether each environmental element should be handled as an obstacle or a road surface obstacle, the obstacle data group 33 as the detected information regarding the obstacle is output to the obstacle risk estimation unit 13, and the road surface obstacle data group 34 as the detected information regarding the road surface obstacle is output to the road surface risk estimation unit 14. The road surface risk estimation unit 14 also outputs a part of the obstacle data group 33 necessary for estimating the road surface risk. For example, for detected information of a puddle which is a type of road surface obstacle, among the pieces of information included in the obstacle data group 33, information regarding a pedestrian existing near the puddle is output from the detected information identification unit 12 to the road surface risk estimation unit 14.

For each obstacle included in the obstacle data group 33, the obstacle risk estimation unit 13 estimates the degree of influence of the obstacle on traveling of the vehicle 2 at each position around the vehicle 2 as the obstacle risk of the vehicle 2 based on the vehicle information data group 36 and the road information data group 35. The obstacle risk estimation result of the obstacle risk estimation unit 13 is output to the obstacle risk map generation unit 15.

For each road surface obstacle included in the road surface obstacle data group 34, the road surface risk estimation unit 14 estimates the degree of influence of the road surface obstacle on traveling of the vehicle 2 at each position around the vehicle 2 as the road surface risk of the vehicle 2 based on a part of the obstacle data group 33 output from the detected information identification unit 12, the vehicle information data group 36, and the road information data group 35. Here, the surrounding situation of the vehicle 2 and a relationship between environmental elements are estimated as the context of the traveling environment of the vehicle 2 based on the obstacle data group 33, the vehicle information data group 36, the road information data group 35, and the like. Then, the degree of “undesirability” of stepping over the road surface obstacle by the wheel of the vehicle 2 at each position around the vehicle 2, that is, the degree of influence on traveling of the vehicle 2 is estimated as the road surface risk of the vehicle 2, based on the estimated context of the traveling environment. The road surface risk estimation result of the road surface risk estimation unit 14 is output to the road surface risk map generation unit 16.

For each obstacle included in the obstacle data group 33, the obstacle risk map generation unit 15 reflects a region representing the obstacle risk estimation result at each position around the vehicle 2 estimated by the obstacle risk estimation unit 13 based on the vehicle information data group 36 and the road information data group 35 and the degree thereof on a two-dimensional map to generate the obstacle risk map data group 37. The generated obstacle risk map data group 37 is output to the traveling control planning unit 17.

For each road surface obstacle included in the road surface obstacle data group 34, the road surface risk map generation unit 16 projects a region representing the road surface risk estimation result at each position around the vehicle 2 estimated by the road surface risk estimation unit 14 based on the context of the traveling environment and the degree thereof on a two-dimensional map to generate the road surface risk map data group 38. The generated road surface risk map data group 38 is output to the traveling control planning unit 17.

The traveling control planning unit 17 plans a traveling track on which the vehicle 2 should travel based on the obstacle risk map data group 37 and the road surface risk map data group 38, and generates a control command value or the like for following the traveling track. The planned traveling track of the vehicle 2, control command value, and the like are output to the information output unit 18 as the traveling control data group 39.

The information acquisition unit 18 outputs the control command value to the actuator group 7 based on the traveling control data group 39. Further, the HMI device group 8 outputs information to be presented to the occupant based on the obstacle risk map data group 37 and the road surface risk map data group 38 acquired from the information output unit 11.

Next, the operation of the electronic control device 3 according to the present embodiment will be described in detail with reference to a specific travel scene of FIG. 6.

In the travel scene of FIG. 6, the vehicle 2 is traveling on a two-lane road, and an object that obstructs the traveling of the vehicle 2 and a road surface condition that affects the traveling exist around the vehicle 2 as environmental elements to be processed by the electronic control device 3. Specifically, the another vehicle 401 is traveling in a lane adjacent to that of the vehicle 2 at a speed slightly lower than that of the vehicle 2. In addition, the pedestrian 402 is walking outside the roadway (for example, a sidewalk). In front of the vehicle 2, the potholes 411 and 412 and the falling objects 421 to 423 are distributed on the road, and the falling object 422 moves in a direction of an arrow. In addition, the puddles 431 and 432 exist. Further, the road edges 441 and 442 exist as boundaries between the road and the outside of the road. These environmental elements have respective characteristics expressed in the detected information included in the sensor detection data group 31 of FIG. 2, and correspond to the respective environmental elements described in the obstacle data group 33 of FIG. 3 or the road surface obstacle data group 34 of FIG. 4.

It is considered to plan an optimal traveling track in such a travel scene. Hereinafter, specific operations will be described using the travel scene of FIG. 6 in the order of the processing described above with reference to FIG. 5.

### (Processing in Information Acquisition Unit 11)

In the travel scene of FIG. 6, the objects and road surface conditions around the vehicle 2 are mainly detected by the external-environment sensor group 4. An object or a road surface condition that does not change for a long time, such as a road edge or a pothole, can also be acquired from the digital road map data provided by the map information managing device 6 or the intellectualized information acquired via the external communication device 9. The information acquisition unit 11 acquires detected information regarding an object and a road surface condition around the vehicle 2 from an appropriate information source according to the configuration of the system, and stores the detected information in the storage unit 30 as the sensor detection data group 31, the intellectualized information data group 32, and the road information data group 35. Here, for the sake of explanation, it is assumed that all pieces of detected information regarding surrounding objects and road surface conditions are detected by the external-environment sensor group 4, and the sensor detection data group 31 illustrated in FIG. 2 is obtained, and a case of performing traveling control for the vehicle 2 using the sensor detection data group 31 of FIG. 2 will be described. Even in a case where the intellectualized information data group 32 and the road information data group 35 are used, processing similar to that for the sensor detection data group 31 can be executed. However, preprocessing such as coordinate conversion may be required.

### (Processing in Detected Information Identification Unit 12)

The detected information identification unit 12 extracts detected information related to traveling of the vehicle 2 based on the sensor detection data group 31 obtained by the information acquisition unit 11. The detected information related to traveling of the vehicle 2 is, for example, detected information related to a region where the vehicle 2 is likely to travel.

Subsequently, the detected information identification unit 12 determines whether to handle an environmental element indicated by each piece of detected information of the sensor detection data group 31 as an “obstacle” or a “road surface obstacle” based on the attribute information. Here, as described above, an object that the vehicle 2 cannot cross over is handled as an “obstacle”. For example, another vehicle, a pedestrian, a falling object having a large height, a road edge (a fence, a guard rail, or the like), and the like are applicable. Conversely, an object that the vehicle 2 can cross over is handled as a “road surface obstacle”. For example, a pothole, a falling object having a small height, a puddle, a bump, a rut, black ice, and the like are applicable.

Here, a falling object corresponds to both the “obstacle” and the “road surface obstacle”, but is preferably classified according to the height. The vehicle 2 can cross over a falling object in a case where a vehicle height (minimum ground clearance) of the vehicle 2 is higher than the height of the falling object. Therefore, in a case where the vehicle height of the vehicle 2 is sufficiently larger than the height 307 in the sensor detection data group 31, the environmental element is determined as a “road surface obstacle”. In the example of the sensor detection data group 31 of FIG. 2, the unknown object 421 is determined as an “obstacle” since it is higher than the vehicle height (40 cm), and the unknown objects 422 and 423 are determined as “road surface obstacles” since they are sufficiently lower than the vehicle height (5 cm). Since the external-environment sensor group 4 cannot usually identify what the falling object is, the type of the falling object is set to “unknown object” in the example of FIG. 2.

In addition, an object for which it can be determined that the vehicle 2 cannot cross over may be handled as an “obstacle” even in a case where the height of the environmental element is sufficiently smaller than the vehicle height of the vehicle 2. For example, in a case where the environmental element is an object such as a small animal, even when the height of the object is sufficiently lower than the vehicle height, it may be determined that the vehicle 2 is not allowed to cross over the environmental element in consideration of the risk that the small animal may hit the wheel due to movement. In such a case, it is preferable to handle a detection target as an “obstacle” regardless of the height of the detection target.

When the determination processing for each environmental element is completed, the detected information identification unit 12 stores detected information corresponding to an “obstacle” in the obstacle data group 33 and stores detected information corresponding to a “road surface obstacle” in the road surface obstacle data group 34 among the pieces of detected information included in the sensor detection data group 31. As a result, each piece of detected information included in the sensor detection data group 31 illustrated in FIG. 2 is classified as the obstacle data group 33 in FIG. 3 or the road surface obstacle data group 34 in FIG. 4, and is stored in the storage unit 30.

### (Processing in Obstacle Risk Estimation Unit 13 and Obstacle Risk Map Generation Unit 15)

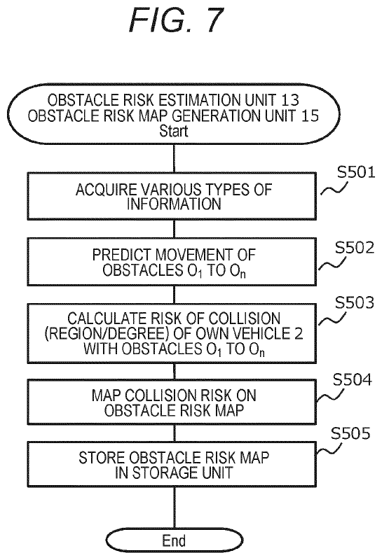

Next, processing in the obstacle risk estimation unit 13 and the obstacle risk map generation unit 15 will be described with reference to the flowchart of FIG. 7.

First, in S501, the obstacle risk map generation unit 15 acquires the obstacle data group 33, the road information data group and the vehicle information data group 36, which are information necessary for generating the obstacle risk map, from the storage unit 30.

Subsequently, the obstacle risk map generation unit 15 calls the obstacle risk estimation unit 13, and estimates the degree of influence of each obstacle represented by the detected information included in the obstacle data group 33 on traveling of the vehicle 2 as the obstacle risk of the vehicle 2 in S502 to S503. Here, for example, in a case where pieces of detected information of obstacles O1 to On are included in the obstacle data group 33, the obstacle risk of the vehicle 2 is estimated by estimating a collision risk of each of the obstacles O1 to On with the vehicle 2.

In S502, the obstacle risk estimation unit 13 predicts the future movement of each obstacle based on the attribute information. The obstacle movement prediction is calculated based on the speed 314 of the obstacle data group 33. For example, a movement track of the obstacle may be linearly predicted under the assumption that the speed 314 is maintained. In addition, based on the shape of a lane included in the road information data group 35, the movement track of the obstacle may be predicted under the assumption that the obstacle travels along the lane.

In S503, the obstacle risk estimation unit 13 calculates a collision risk with the vehicle 2 for each obstacle based on the movement prediction result in S502 and the traveling state (the speed, acceleration, or the like) of the vehicle 2 included in the vehicle information data group 36. Here, the collision risk is a concept including a region of a place where the obstacle and the vehicle 2 are likely to collide and a possibility thereof.

Subsequently, in S504, the obstacle risk map generation unit 15 generates the obstacle risk map by mapping the collision risk (obstacle risk) of each obstacle estimated by the obstacle risk estimation unit 13 in S502 to S503 on a two-dimensional map. Then, in S505, information regarding the generated obstacle risk map is stored in the storage unit 30 as the obstacle risk map data group 37.

FIG. 8 illustrates an example of the obstacle risk map generated based on the obstacle data group 33 of FIG. 3 in the travel scene of FIG. 6. In the obstacle risk map of FIG. 8, regions corresponding to the obstacle risks of the another vehicle 401, the pedestrian 402, the unknown object 421, and the road edges 441 and 442 determined as obstacles by the detected information identification unit 12 are mapped as obstacle risks 701, 702, 721, 741, and 742, respectively. In FIG. 8, the degree of obstacle risk is expressed by a color intensity, and the darker the color, the higher the degree of risk. The degree of risk may be expressed at several discrete levels (for example, high risk, medium risk, and low risk), or may be expressed by continuous numerical values. Information indicating such an obstacle risk map is stored in the storage unit 30 as the obstacle risk map data group 37 by the processing of the flowchart of FIG. 7.

Here, in FIG. 8, the positions of the another vehicle 401 and the pedestrian 402 among the risk source obstacles are also displayed together with the obstacle risks, but it can be seen that the obstacle risks 701 and 702 corresponding to these obstacles are distributed while being shifted from the positions of the obstacles. This is because a region where each obstacle can actually collide with the vehicle 2 is calculated based on the movement prediction for each obstacle and the traveling state of the vehicle 2. For example, since a region where the another vehicle 401 is present at this time point is positioned behind the vehicle 2 in the traveling direction of the vehicle 2, the another vehicle 401 does not collide with the vehicle 2 in the region. The another vehicle 401 and the vehicle 2 are likely to actually collide with each other in a case where the vehicle 2 makes lane change and moves to the adjacent lane, and thus the obstacle risk 701 is distributed on the adjacent lane ahead of the vehicle 2. The reason why the distribution of the obstacle risk 701 is interrupted in the middle of the adjacent lane ahead of the vehicle 2 is that the speed of the vehicle 2 is higher than that of the another vehicle 401, a sufficient inter-vehicle distance can be maintained as the vehicle 2 travels forward, and the risk of collision is reduced.

### (Processing in Road Surface Risk Estimation Unit 14 and Road Surface Risk Map Generation Unit 16)

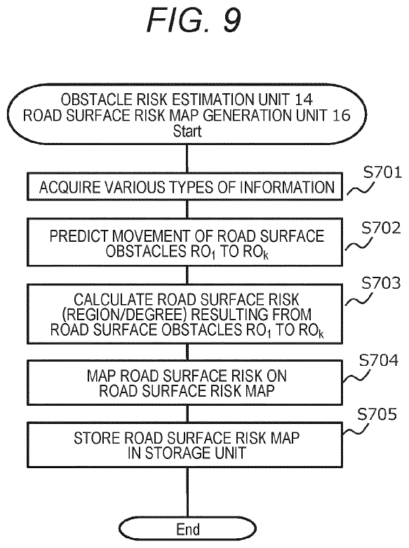

Next, processing in the road surface risk estimation unit 14 and the road surface risk map generation unit 16 will be described with reference to the flowchart of FIG. 9.

First, in S701, the road surface risk map generation unit 16 acquires the obstacle data group 33, the road surface obstacle data group 34, the road information data group 35, and the vehicle information data group 36, which are information necessary for generating the road surface risk map, from the storage unit 30.

Subsequently, the road surface risk map generation unit 16 calls the road surface risk estimation unit 14, and estimates the degree of influence of each road surface obstacle represented by the detected information included in the road surface obstacle data group 34 on traveling of the vehicle 2 as the road surface risk of the vehicle 2 in S702 to S703. Here, for example, in a case where pieces of detected information of road surface obstacles RO1 to ROn are included in the road surface obstacle data group 34, the road surface risk of the vehicle 2 is estimated by estimating the degree of influence on traveling of the vehicle 2 when the wheel of the vehicle 2 passes on these road surface obstacles RO1 to ROn.

In S702, the road surface risk estimation unit 14 predicts the future movement of a road surface obstacle that may move based on the attribute information. Most road surface obstacles are caused by the road surface and thus do not move, but light falling objects may move by being carried by the wind. In such a case, the road surface obstacle movement prediction is performed similarly to S502 of FIG. 7 in the processing in the obstacle risk estimation unit 13.

Next, in S703, the road surface risk estimation unit 14 calculates the degree of “undesirability” of stepping over the road surface obstacle by the vehicle 2 and a region thereof as the road surface risk based on the movement prediction result of S702, the traveling state (the speed, acceleration, or the like) of the vehicle 2 included in the vehicle information data group 36, the information of the traveling road included in the road information data group 35, and the like for each road surface obstacle.

In a case of a stationary road surface obstacle, the region of the road surface risk corresponds to a region where the road surface obstacle is distributed. On the other hand, in a case of a moving road surface obstacle, based on the movement prediction result of S702 and the traveling state of the vehicle 2, the region of the road surface risk corresponds to a region where the moving road surface obstacle and the vehicle 2 can overlap at the same time (equivalent to the region of the collision risk of the obstacle).

The degree of road surface risk is calculated by the degree of “undesirability” of stepping over the road surface obstacle by the vehicle. The “undesirability” varies in nature depending on the type of road surface obstacle, the traveling state of the own vehicle 2, and the environment thereof. Broadly speaking, the degree of “undesirability” is calculated separately for a case where an undesirable influence is exerted on traveling of the own vehicle 2 when the own vehicle 2 steps over the road surface obstacle and a case where an undesirable influence is exerted on the periphery of the own vehicle 2.

The former corresponds to almost all road surface obstacles. For example, in a case of a road surface obstacle with a step on the road surface, such as a pothole, a bump, a rut, or a falling object, when the road surface obstacle is stepped over, not only the ride comfort of the vehicle 2 is affected, but also the traveling of the vehicle 2 may not be safely controlled. In addition, in a case of black ice or a puddle, a slip or hydroplaning phenomenon may occur, and the safety of traveling of the vehicle 2 may be adversely affected.

The latter corresponds to a road surface obstacle such as a puddle. For example, when the vehicle travels on a puddle, the vehicle may splash water to a pedestrian or a two-wheeled vehicle in the vicinity of the puddle in some cases, resulting in driving without consideration for the surroundings. Therefore, in order to avoid the undesirable situation, when a person is driving, the person avoids a puddle or slows down when a pedestrian is nearby.

As described above, the degree of “undesirability” of stepping over the road surface obstacle changes depending on the context such as the state of the road surface obstacle itself (the size of the step or the like), the traveling state of the vehicle 2 (the speed or the like), and the situation of the traveling environment (the presence or absence of a nearby pedestrian or the like) according to the type of the road surface obstacle. Therefore, the road surface risk estimation unit 14 calculates the road surface risk based on the context.

For example, the degree of influence of a pothole on the ride comfort and the safety varies depending on the depth and size (width and depth) of the depression. In a case of a deep and narrow depression, there is a high risk that the wheel is stuck and is not controlled. On the other hand, in a case of a shallow and wide depression, even when the wheel steps over the depression, there is almost no problem in terms of safety, and the ride comfort is only slightly deteriorated. The same applies to bumps, ruts, and falling objects, and the height of the road surface obstacle contributes to the degree of influence on ride comfort and safety. Therefore, it is desirable to consider the height of the road surface obstacle in calculating the road surface risk.

In addition, the material of the road surface obstacle also affects the degree of influence on ride comfort and safety. The harder and heavier the material of the road surface obstacle, the greater the impact received by the vehicle 2. Therefore, it is desirable to calculate the degree of road surface risk according to the material of the road surface obstacle.

In addition, the speed of the vehicle 2 also affects the degree of influence on ride comfort and safety. As the speed increases, the influence of the step of the road surface obstacle increases. In a case of high-speed traveling, the risk of losing control of traveling increases even with a step that does not cause a problem during low-speed traveling. In addition, a slip or hydroplaning phenomenon due to black ice, a puddle, or the like is likely to occur during high-speed traveling, and the power of water splashing due to the puddle also increases as the speed increases. Therefore, it is desirable to consider the speed of the own vehicle 2 in calculating the road surface risk.

In a case where an adverse effect on the periphery of the vehicle 2 is expressed as the road surface risk, the peripheral situation of the road surface obstacle affects the degree of road surface risk. Water splashing of a puddle with respect to the surroundings is undesirable when there is an obstacle affected by the water splashing, such as a pedestrian or a bicycle, near the puddle. Conversely, in a case where such an obstacle does not exist, there is no problem in terms of splashing water. Therefore, for example, in a case where the road surface obstacle is a puddle, the presence or absence of an obstacle such as a pedestrian or a bicycle exists near the puddle may be checked, and the degree of road surface risk may be changed according to the presence or absence. Alternatively, in consideration of a case where the external-environment sensor group 4 cannot detect an obstacle, the degree of road surface risk for a puddle near a sidewalk may be set to high, and the degree of road surface risk for other puddles may be set to low.

In S703, the road surface risk estimation unit 14 can calculate the road surface risk of each road surface obstacle as described above based on the characteristic of each road surface obstacle represented by the sensor detection data group 31 of FIG. 2 and the road surface obstacle data group 34 of FIG. 4 and the traveling state of the vehicle 2 represented by the vehicle information data group 36.

Once the road surface risk estimation unit 14 calculates the road surface risk of each road surface obstacle in S703, the road surface risk map generation unit 16 maps the road surface risk on a two-dimensional map and generates the road surface risk map in S704. As a result, the degree of traveling risk in the road surface risk map is determined based on the degree of road surface risk estimated by the road surface risk estimation unit 14, that is, the degree of influence of the road surface obstacle on traveling of the vehicle 2. Then, in S705, information regarding the generated road surface risk map is stored in the storage unit 30 as the road surface risk map data group 38.

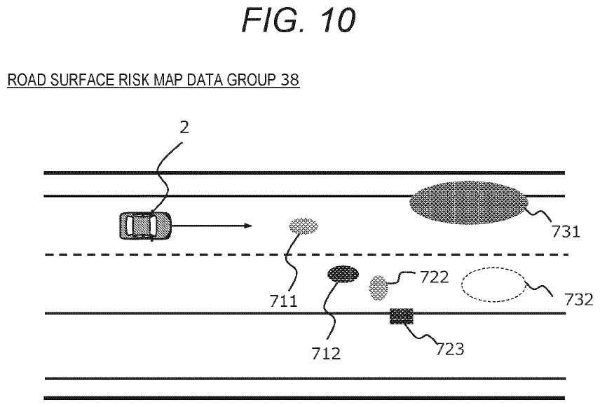

FIG. 10 is an example of the road surface risk map generated based on the road surface obstacle data group 34 of FIG. 4 in the travel scene of FIG. 6. In the road surface risk map of FIG. 10, regions corresponding to the road surface risks of the potholes 411 and 412, the unknown objects 422 and 423, and the puddles 431 and 432 determined as road surface obstacles by the detected information identification unit 12 are mapped as road surface risks 711, 712, 722, 723, 731, and 732, respectively. In FIG. 10, the degree of road surface risk is expressed by a color intensity, and the darker the color, the higher the degree of risk. The degree of risk may be expressed at several discrete levels (for example, high risk, medium risk, and low risk), or may be expressed by continuous numerical values. Information indicating such a road surface risk map is stored in the storage unit 30 as the road surface risk map data group 38 by the processing of the flowchart of FIG. 9.

Here, in FIG. 10, since the pothole 412 has a larger depression depth than the pothole 411, the road surface risk 712 is larger than road surface risk 711.

The road surface risk 723 of the unknown object 423 is larger than the road surface risk 722 of the unknown object 422. Referring to the road surface obstacle data group 34 of FIG. 4, the unknown object 422 and the unknown object 423 both have the same value of the height 327 from the viewpoint of the height of the step, but it can be seen from the value of the reflection intensity 328 that the reflection intensity of the unknown object 423 is higher. As for the reflection intensity, in a case of objects positioned at similar distances, the reflection intensity increases as a harder material is used to repel electromagnetic waves. Therefore, it is estimated that the unknown object 422 is harder than the unknown object 423 from a difference in value of the reflection intensity 328. In addition, as described above, since the unknown object 422 is moved by the wind, it can be estimated that the material of the unknown object 422 is light. Therefore, the unknown object 422 can be determined to have a smaller influence when being stepped over by the wheel of the vehicle 2 than the unknown object 423. As a result, the road surface risk 722 is smaller in the road surface risk map of FIG. 10.

Further, when the road surface risk 731 of the puddle 431 and the road surface risk 732 of the puddle 432 are compared, the road surface risk 731 of the puddle 731 appears on the road surface risk map of FIG. 10, whereas the road surface risk 732 of the puddle 732 is indicated by a broken line. This indicates that the puddle 732 is not mapped as a road surface risk on the road surface risk map. The reason is that, from the viewpoint of water splashing due to traveling over a puddle, while the puddle 431 near the pedestrian 402 should be avoided, the puddle 432 with no obstacle affecting the surroundings positioned therearound does not need to be considered. Alternatively, it can be considered that it is determined that the puddle 731 near the sidewalk should be avoided and the other puddles do not need to be considered.

### (Processing in Traveling Control Planning Unit 17)

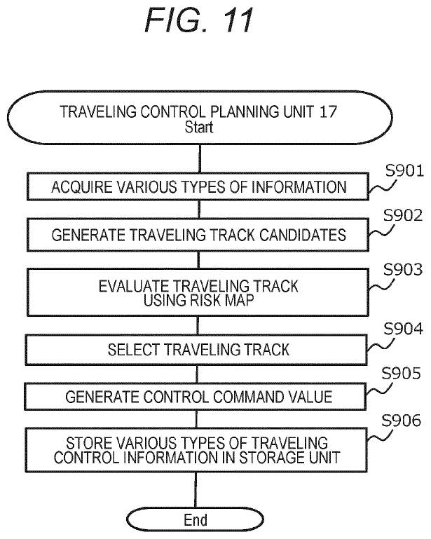

Processing in the traveling control planning unit 17 will be described with reference to the flowchart of FIG. 11.

First, in S901, the traveling control planning unit 17 acquires the road information data group 35, the vehicle information data group 36, the obstacle risk map data group 37, and the road surface risk map data group 38, which are necessary for the processing, from the storage unit 30.

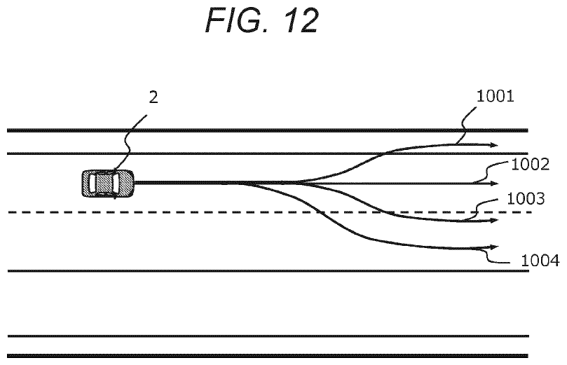

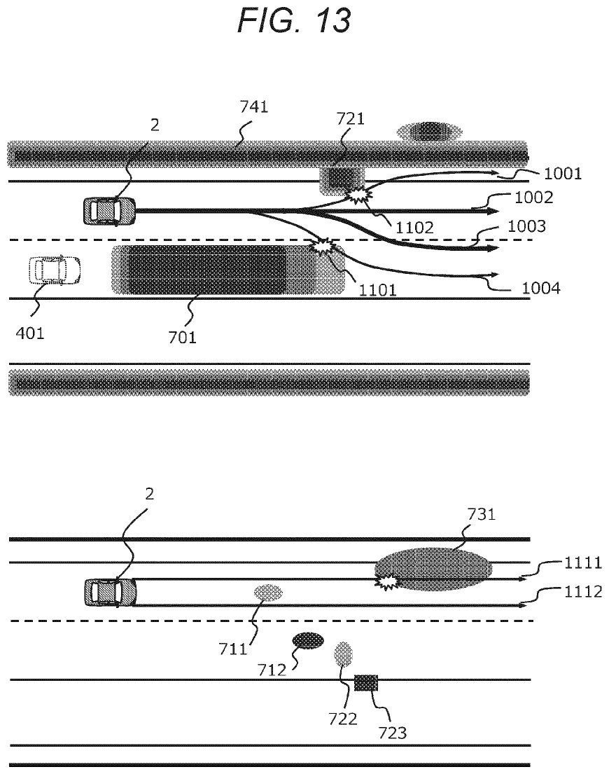

Subsequently, the traveling control planning unit 17 generates traveling track candidates based on the road information data group 35 in consideration of the lane shape and the traffic rules of the road on which the vehicle 2 is traveling. FIG. 12 illustrates an example of the traveling track candidates. In FIG. 12, a traveling track candidate 1002 in a case of following the lane on which the vehicle 2 is currently traveling, a traveling track candidate 1004 in a case where the vehicle 2 make lane change lane to the adjacent lane, and traveling track candidates 1001 and 1003 offset to the left and right from the center of the own lane are generated.

A method of generating the traveling track candidates is not limited. Although the most desirable traveling track is selected by evaluating each traveling track after generating the traveling track candidates first in the flowchart of FIG. 11, a more desirable traveling track may be searched for while evaluating the traveling track.

Next, in S903, the traveling control planning unit 17 evaluates each of the plurality of traveling track candidates generated in S902 by using the obstacle risk map data group 37, the road surface risk map data group 38, and the like, and selects a traveling track candidate determined to be the best among the plurality of traveling track candidates as a traveling track to be used for traveling control planning in S904. Specifically, for each traveling track candidate, the obstacle risk on the obstacle risk map data group 37 through which the vehicle body of the vehicle 2 passes along the traveling track candidate and the road surface risk on the road surface risk map data group 38 through which the wheel of the vehicle 2 passes along the traveling track candidate are specified, and each traveling track candidate is evaluated based on a combination thereof. As a result, a traveling track evaluated as the best is selected as a traveling track for traveling control for the vehicle 2. Here, two methods for combining the obstacle risk and the road surface risk evaluation are considered.

The first method is a method for simultaneously evaluating the obstacle risk and the road surface risk. In this case, for example, a combined cost function J(T) as in the following Equation (1) obtained by weighting and combining a cost function f(T) related to an obstacle risk that the vehicle body of the vehicle 2 passes along a traveling track candidate T, a cost function g(T) related to a road surface risk that the wheel of the vehicle 2 passes, and a cost function h(T) based on other evaluation indexes such as ride comfort resulting from a track shape is prepared, and a traveling track candidate having the minimum combined cost function J(T) is selected as the traveling track.

J(T)=a*f(T)+b*g(T)+c*h(T) (1)
(where a, b, and c are weighting coefficients)

As an example of a method of calculating the cost functions f(T) and g(T) in Equation (1), a method of obtaining the sum of products or the maximum value of the degrees of risk of the risk region through which the vehicle body or the wheel passes along the traveling track candidate T can be considered.

The second method is a method of sequentially evaluating the obstacle risk and the road surface risk. First, the obstacle risk of each traveling track candidate T is evaluated by the cost function f(T) of Equation (1) above, and those that cannot be candidates from the viewpoint of safety are excluded. Then, the road surface risk is evaluated by the cost function g(T) (or a weighted combination of the cost functions g(T) and h(T)) for the remaining traveling track candidate T, and the best one is selected. The vehicle 2 needs to reliably avoid the obstacle risk expressed in the obstacle risk map as a vehicle body. On the other hand, the road surface risk expressed in the road surface risk map may be avoided by the wheel even if the vehicle body crosses over the road surface risk, or may be allowed to be stepped over by the wheel from the viewpoint of safety. Therefore, the obstacle risk is more restricted, and the traveling track candidates that cannot be selected by evaluating the obstacle risk first as described above are screened off, so that the number of candidates for the road surface risk that needs to be evaluated on a wheel basis can be effectively decreased. The evaluation of the road surface risk performed for each traveling track candidate on a wheel basis has a problem that the amount of calculation increases by the number of wheels. However, it is possible to reduce the number of traveling track candidates to be evaluated and reduce the amount of calculation by evaluating the obstacle risk on a vehicle basis first in this manner.

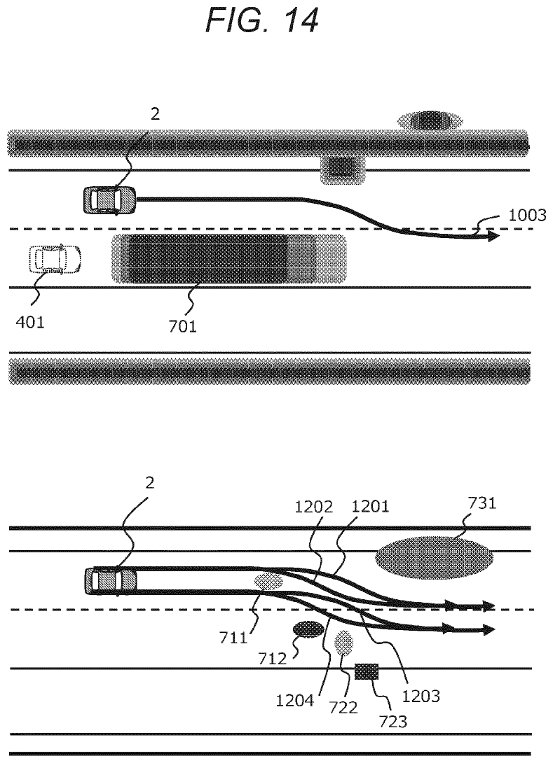

With reference to FIGS. 13 and 14, a flow of evaluating and selecting a traveling track candidate by a combination of the obstacle risk map and the road surface risk map will be described according to the second method for evaluating the traveling track candidates.

The upper diagram of FIG. 13 illustrates a state in which the traveling track candidate 1001 to 1004 of FIG. 12 are mapped on the obstacle risk map of FIG. 8. Here, it can be seen that the traveling track candidate 1001 overlaps the obstacle risk 721 at a position 1102, and the traveling track candidate 1004 overlaps the obstacle risk 701 at a position 1101. This means that the vehicle body of the vehicle 2 hits the unknown object 421 in the traveling track candidate 1001, and the vehicle 2 collides with the another vehicle 401 in the adjacent lane when the vehicle 2 makes lane change in the traveling track candidate 1004. Since both the traveling track candidates are appropriate from the viewpoint of safety, they are rejected at the time of evaluating the obstacle risk.

Subsequently, for the remaining traveling track candidates 1002 and 1003, these road surface risks are evaluated on the road surface risk map. The lower diagram of FIG. 13 illustrates a state in which wheel tracks 1111 and 1112 in the traveling track candidate 1002 are mapped on the road surface risk map. Here, it can be seen that the wheel track 1111 representing the track of the left wheel of the vehicle 2 overlaps the road surface risk 731 of the puddle 431. As a result, it can be seen that the traveling track candidate 1002 has a risk of splashing water on the pedestrian 402 and is undesirable in this respect.

On the other hand, the upper diagram of FIG. 14 illustrates a state in which the traveling track candidates 1001, 1002, and 1004 are excluded from the upper diagram of FIG. 13 and only the traveling track candidate 1003 is mapped on the obstacle risk map. In addition, the lower diagram of FIG. 14 illustrates a state in which wheel tracks 1201, 1202, 1203, and 1204 in the traveling track candidate 1003 are mapped on the road surface risk map. Here, it can be seen that, in the traveling track candidate 1003, the vehicle body of the vehicle 2 does not overlap any obstacle risk, none of the wheel tracks 1201 to 1204 overlaps the road surface risk, and all the obstacle risks and the road surface risks can be avoided. Therefore, since it is derived that the traveling track candidate 1002 is more desirable (the result of the cost function is small) by comparing the traveling track candidate 1003 and the traveling track candidate 1003, the traveling track candidate 1003 is selected as a traveling track used for a control plan for the vehicle 2.

In S903, as described above, the obstacle risk is evaluated first, the road surface risk is evaluated based on the evaluation result, and the optimal traveling track can be determined from among the plurality of traveling track candidates. As a result, it is possible to determine the traveling track by prioritizing avoidance of the traveling risk on the obstacle risk map by the vehicle body of the vehicle 2 over avoidance of the traveling risk on the road surface risk map by the wheel of the vehicle 2.

In FIG. 14, an example in which the traveling track candidate 1003 in which all the wheel tracks 1201 to 1204 do not overlap the road surface risk is selected as the traveling track in the evaluation of the road surface risk has been described. However, there is not necessarily a traveling track candidate in which all the wheel tracks do not overlap the road surface risk. In such a case, even if any wheel track overlaps the road surface risk, it is preferable to select a traveling track candidate having the minimum cost function, that is, a traveling track candidate having the smallest influence on the vehicle 2 during traveling due to the road surface obstacle corresponding to the road surface risk, as a traveling track on which the vehicle 2 should travel.

Furthermore, in this case, the front wheel and the rear wheel of the vehicle 2 may be distinguished from each other, and the cost (the degree of influence) when each wheel track overlaps the road surface risk may be evaluated. For example, in a front wheel-drive vehicle, since it is considered that the degree of influence of the road surface obstacle on the front wheels, which are driving wheels, is larger than that on the rear wheels, the cost when the track of the front wheel overlaps with the road surface risk is set to be larger than that for the track of the rear wheel. On the other hand, in a rear wheel-drive vehicle, the cost when the track of the rear wheel overlaps the road surface risk is set to be larger than that for the track of the front wheel. In this way, it is possible to determine the traveling track by distinguishing a priority of avoidance of the traveling risk on the road surface risk map by the front wheel of the vehicle 2 and a priority of avoidance of the traveling risk on the road surface risk map by the rear wheel of the vehicle 2. Therefore, even in a case where the degree of influence of the road surface obstacle is greatly different between a driving wheel and a non-driving wheel (driven wheel), for example, due to black ice, it is possible to determine the optimum traveling track by giving priority to avoidance of the road surface risk by the front wheel or rear wheel that is the driving wheel. Although an example in which the priority of the avoidance of the road surface risk is different between the driving wheel and the non-driving wheel has been described above, the priority of the avoidance of the road surface risk may be different between the front wheel and the rear wheel regardless of which is the driving wheel.

As described above, once the traveling track of the vehicle 2 is selected in S904, the traveling control planning unit 17 calculates the control command value for the actuator group 7 for causing the vehicle 2 to follow the traveling track in S905. Then, in S906, the traveling control information including the information of the traveling track selected in S904 and the control command value calculated in S905 is stored in the storage unit 30 as the traveling control data group 39.

As described above, in the electronic control device 3, it is possible to generate a natural target track based on the actual state of the road surface obstacle by calculating, as the road surface risk, the undesirability of stepping over the road surface obstacle around the vehicle 2 by the wheel of the vehicle 2 and generating a target track in such a way as to minimize the road surface risk through which the wheel track of the vehicle 2 passes. For example, it is possible to generate a traveling track in which a pothole existing at the center of a traveling lane is passed without being avoided as a vehicle body.

In addition, by separately configuring the obstacle risk regarding the obstacle that needs to be avoided by the entire vehicle body of the vehicle 2 and the road surface risk regarding the road surface obstacle that affects the vehicle 2 when being stepped over by the wheel of the vehicle 2, it is possible to separately calculate the risk related to the vehicle body and the risk related to the wheel at the time of evaluating the traveling track. When expressed as the same risk, the risk evaluation for each wheel is required for all obstacles and road surface obstacles, and thus the amount of calculation increases. However, by separately expressing the risks, the number of risk evaluation targets for each wheel can be reduced, and the amount of calculation can thus be reduced.

According to one embodiment of the present invention described above, the following effects are exhibited.

(1) The electronic control device 3 mounted on the vehicle 2 includes: the information acquisition unit 11 that acquires information (the sensor detection data group 31 and the intellectualized information data group 32) regarding an environmental element around the vehicle 2, the environmental element including at least a road surface obstacle that is passable by the vehicle 2 on a road surface; a risk map generation unit (the obstacle risk map generation unit 15 and the road surface risk map generation unit 16) that generates a risk map (the obstacle risk map and the road risk map) representing the degree of traveling risk of the vehicle 2 at each position around the vehicle 2 based on the information acquired by the information acquisition unit 11; and the traveling control planning unit 17 that determines a traveling track for traveling control for the vehicle 2 based on the risk map generated by the risk map generation unit. The traveling control planning unit 17 determines the traveling track based on the degree of traveling risk due to the road surface obstacle on the risk map through which a wheel track of the vehicle 2 in the traveling track passes (S903 and S904). With this configuration, it is possible to generate a natural target track according to the degree of traveling risk of the vehicle 2 due to the road surface obstacle.

(2) The sensor detection data group 31 and the intellectualized information data group 32, which are a set of the information acquired by the information acquisition unit 11, include the obstacle information regarding an obstacle that is not passable by the vehicle 2 and the road surface obstacle information regarding a road surface obstacle. The risk map generation unit includes the obstacle risk map generation unit 15 that generates the obstacle risk map representing the degree of traveling risk related to the vehicle body of the vehicle 2 at each position around the vehicle 2 based on the obstacle information, and the road surface risk map generation unit 16 that generates the road surface risk map representing the degree of traveling risk related to the wheel of the vehicle 2 at each position around the vehicle 2 based on the road surface obstacle information. In this way, when determining the traveling track, the traveling risk due to the obstacle and the traveling risk due to the road surface obstacle can be evaluated separately, so that an appropriate traveling track can be generated.

(3) The traveling control planning unit 17 generates the traveling track candidates 1001 to 1004 (S902), and determines the traveling track based on the degree of traveling risk on the obstacle risk map through which the vehicle body of the vehicle 2 passes in each traveling track candidate and the degree of traveling risk on the road surface risk map through which the wheel of the vehicle 2 passes in each traveling track candidate (S903 and S904). With this configuration, it is possible to determine an appropriate traveling track in which an influence of the road surface obstacle is reduced while reliably avoiding a collision with the obstacle.

(4) The electronic control device 3 includes the road surface risk estimation unit 14 that estimates the degree of influence of the road surface obstacle on traveling of the vehicle 2 based on the characteristic of the road surface obstacle indicated by the information included in the sensor detection data group 31 and the intellectualized information data group 32 and the traveling state and the peripheral situation of the vehicle 2. The road surface risk map generation unit 16 determines the degree of traveling risk in the road surface risk map based on the degree of influence estimated by the road surface risk estimation unit 14 (S704). With this configuration, it is possible to generate the road surface risk map appropriately representing the degree of traveling risk due to the road surface obstacle at each position around the vehicle 2.

(5) The road surface risk estimation unit 14 calculates the degree of influence of the road surface obstacle on the traveling of the vehicle 2 based on the speed of the vehicle 2 (S703). With this configuration, the degree of the road surface risk can be appropriately calculated in consideration of the degree of influence of the speed of the vehicle 2 when the vehicle 2 steps over the road surface obstacle on the ride comfort and the safety.

(6) In a case where the road surface obstacle has a step, the road surface risk estimation unit 14 may calculate the degree of influence of the road surface obstacle on the traveling of the vehicle 2 based on the height of the step or the material (S703). With this configuration, the degree of the road surface risk can be appropriately calculated in consideration of the degree of influence of the height and the material of the road surface obstacle on the ride comfort and safety when the road surface obstacle is stepped over.

(7) In a case where the road surface obstacle is a puddle and a pedestrian exists near the road surface obstacle, or in a case where the road surface obstacle is positioned near a sidewalk, the road surface risk estimation unit 14 may set the degree of influence of the road surface obstacle on the traveling of the vehicle 2 high (S703). With this configuration, it is possible to appropriately set the degree of road surface risk in consideration of an adverse effect on the periphery of the vehicle 2 when stepping over the road surface obstacle.

(8) The traveling control planning unit 17 can determine the traveling track by prioritizing avoidance of the traveling risk on the obstacle risk map by the vehicle body of the vehicle 2 over avoidance of the traveling risk on the road surface risk map by the wheel of the vehicle 2 (S903 and S904). With this configuration, the amount of calculation when determining the traveling track can be reduced.

(9) The traveling control planning unit 17 can determine the traveling track by distinguishing a priority of avoidance of the traveling risk on the road surface risk map by the front wheel of the vehicle 2 and a priority of avoidance of the traveling risk on the road surface risk map by the rear wheel of the vehicle 2 (S903 and S904). With this configuration, it is possible to determine the optimum traveling track in a case where the degree of influence of the road surface obstacle is greatly different between a driving wheel and a non-driving wheel.

(10) The electronic control device 3 includes the detected information identification unit 12 that classifies the information acquired by the information acquisition unit 11 as the obstacle information or the road surface obstacle information. Specifically, the information acquired by the information acquisition unit 11 includes detected information generated by detecting the environmental element by the external-environment sensor group 4 mounted on the vehicle 2. In a case where it can be determined that the environmental element corresponding to the detected information is crossable by the vehicle 2, the detected information identification unit 12 determines that the environmental element is a road surface obstacle, and otherwise, determines that the environmental element is an obstacle, and classifies the detected information as the obstacle information or the road surface obstacle information. With this configuration, the detected information of the external-environment sensor group 4 can be appropriately classified into the obstacle information used for generating the obstacle risk map and the road surface obstacle information used for generating the road surface risk map.

Note that the embodiment described above is an example, and the present invention is not limited thereto. That is, various applications are possible, and various embodiments are included in the scope of the present invention.

For example, in the above embodiment, the region of the obstacle risk or the road surface risk is expressed in a predetermined shape, but may be expressed in units of cells of a grid-like map, or may be expressed in an aggregate of a plurality of cells.

For example, in the above embodiment, in the electronic control device 3, each processing is assumed to be performed by the same processing unit 10 and storage unit 30, but a plurality of processing units 10 or a plurality of storage units 30 may be provided, and each processing may be performed by the plurality of different processing units and storage units. In this case, for example, processing software having a similar configuration is mounted in each storage unit, and the respective processing units perform the processing in a cooperative manner.

In addition, each processing performed by the electronic control device 3 is implemented by executing a predetermined operation program using a processor and a RAM, but can also be implemented by unique hardware as necessary. In addition, in the above embodiment, the external-environment sensor group, the vehicle sensor group, and the actuator group, the HMI device group, the external communication device are described as individual devices, but any two or more of them may be combined as necessary.

In addition, the drawings illustrate control lines and information lines considered to be necessary for describing the embodiment, and do not necessarily illustrate all the control lines and information lines included in an actual product to which the present invention is applied. In practice, it can be considered that almost all configurations are interconnected.

### REFERENCE SIGNS LIST

1 vehicle system
2 vehicle
3 electronic control device
4 external-environment sensor group
5 vehicle sensor group
6 map information managing device
7 actuator group
8 HMI device group
9 external communication device
10 processing unit
11 information acquisition unit
12 detected information identification unit
13 obstacle risk estimation unit
14 road surface risk estimation unit
15 obstacle risk map generation unit
16 road surface risk map generation unit
17 traveling control planning unit
18 information output unit
30 storage unit
31 sensor detection data group
32 intellectualized information data group
33 obstacle data group
34 road surface obstacle data group
35 road information data group
36 vehicle information data group
37 obstacle risk map data group
38 road surface risk map data group
39 traveling control data group
40 communication unit

1. An electronic control device mounted on a vehicle, the electronic control device comprising:
an information acquisition unit that acquires information regarding an environmental element around the vehicle, the environmental element including at least a road surface obstacle that is passable by the vehicle on a road surface;
a risk map generation unit that generates a risk map representing a degree of traveling risk of the vehicle at each position around the vehicle based on the information; and
a traveling control planning unit that determines a traveling track for traveling control for the vehicle based on the risk map, wherein the traveling control planning unit determines the traveling track based on the degree of traveling risk due to the road surface obstacle on the risk map through which a wheel track of the vehicle in the traveling track passes.

2. The electronic control device according to claim 1, wherein
the information includes obstacle information regarding an obstacle that is not passable by the vehicle and road surface obstacle information regarding the road surface obstacle, and
the risk map generation unit includes:
an obstacle risk map generation unit that generates an obstacle risk map representing the degree of traveling risk related to a vehicle body of the vehicle at each position around the vehicle based on the obstacle information; and
a road surface risk map generation unit that generates a road surface risk map representing the degree of traveling risk related to a wheel of the vehicle at each position around the vehicle based on the road surface obstacle information.

3. The electronic control device according to claim 2, wherein the traveling control planning unit generates a plurality of traveling track candidates, and determines the traveling track based on the degree of traveling risk on the obstacle risk map through which the vehicle body of the vehicle passes in each traveling track candidate and the degree of traveling risk on the road surface risk map through which the wheel of the vehicle passes in each traveling track candidate.

4. The electronic control device according to claim 2, further comprising a road surface risk estimation unit that estimates a degree of influence of the road surface obstacle on traveling of the vehicle based on a characteristic of the road surface obstacle indicated by the information and a traveling state of the vehicle,
wherein the road surface risk map generation unit determines the degree of traveling risk in the road surface risk map based on the degree of influence estimated by the road surface risk estimation unit.

5. The electronic control device according to claim 4, wherein the road surface risk estimation unit calculates the degree of influence based on a speed of the vehicle.

6. The electronic control device according to claim 4, wherein the road surface risk estimation unit calculates the degree of influence based on a height of a step in a case where the road surface obstacle has the step.

7. The electronic control device according to claim 4, wherein the road surface risk estimation unit calculates the degree of influence based on a material of a step in a case where the road surface obstacle has the step.

8. The electronic control device according to claim 2, further comprising a road surface risk estimation unit that estimates a degree of influence on a periphery of the vehicle when the vehicle travels over the road surface obstacle based on a characteristic of the road surface obstacle indicated by the information and a peripheral situation of the vehicle,
wherein the road surface risk map generation unit determines the degree of traveling risk in the road surface risk map based on the degree of influence estimated by the road surface risk estimation unit.

9. The electronic control device according to claim 8, wherein the road surface risk estimation unit sets the degree of influence high in a case where the road surface obstacle is a puddle and a pedestrian exists near the road surface obstacle.

10. The electronic control device according to claim 8, wherein the road surface risk estimation unit sets the degree of influence high in a case where the road surface obstacle is a puddle and the road surface obstacle is positioned near a sidewalk.

11. The electronic control device according to claim 3, wherein the traveling control planning unit determines the traveling track by prioritizing avoidance of the traveling risk on the obstacle risk map by the vehicle body of the vehicle over avoidance of the traveling risk on the road surface risk map by the wheel of the vehicle.

12. The electronic control device according to claim 11, wherein the traveling control planning unit determines the traveling track by distinguishing a priority of avoidance of the traveling risk on the road surface risk map by a front wheel of the vehicle and a priority of avoidance of the traveling risk on the road surface risk map by a rear wheel of the vehicle.

13. The electronic control device according to claim 2, further comprising a detected information identification unit that classifies the information acquired by the information acquisition unit as the obstacle information or the road surface obstacle information.

14. The electronic control device according to claim 13, wherein
the information includes detected information generated by detecting the environmental element by a sensor mounted on the vehicle, and
the detected information identification unit determines that the environmental element corresponding to the detected information is the road surface obstacle in a case where it is determined that the environmental element is crossable by the vehicle, and otherwise, the detected information identification unit determines that the environmental element is the obstacle, and the detected information identification unit classifies the detected information as the obstacle information or the road surface obstacle information.
